(19) United States
(12) Patent Application Publication
(10) Pub. No.: US 2010/0328619 A1
(43) Pub. Date: Dec. 30, 2010

(54) COOLING CELL FOR LIGHT MODULATOR

(76) Inventors: Mark A. Harland, Hilton, NY (US); James Mazzarella, Fairport, NY (US)

Correspondence Address: Raymond L. Owens;Patent Legal Staff, Eastman Kodak Company, 343 State Street, Rochester, NY, 14650-2201, US

(21) Appl. No.: 12/490,371

(22) Filed: Jun. 24, 2009

(51) Int. Cl. G03B 21/16; F28D 15/00

(52) U.S. Cl. 353/54; 165/104.33

(57) ABSTRACT

A cooling cell for drawing heat from a light modulator has an enclosure for conducting a fluid coolant. The enclosure has a fluid coolant inlet disposed to receive fluid coolant under pressure and a fluid conduit to provide fluid communication from the fluid coolant inlet to a nozzle. A well cavity surrounds the nozzle and has a number of fins that extend radially upward from a bottom of the well cavity and outward from the well cavity along a shallow cavity that is peripheral to the well cavity and is shallower than the well cavity. The well cavity is formed within a protruding element that protrudes outward from a portion of an external surface of the enclosure. The protruding element provides a component mounting surface that lies behind the bottom of the well cavity. There is at least one fluid coolant discharge outlet for discharging fluid coolant from the enclosure.

### FIELD OF THE INVENTION

This invention generally relates to apparatus for cooling electro-optical components and more particularly relates to an apparatus for cooling a spatial light modulator.

### BACKGROUND OF THE INVENTION

Projectors and other large-scale electronic imaging systems use lasers and other high-intensity light sources for forming images. Light from these sources is directed to spatial light modulators (SLMs) such as digital micromirror devices (DMDs) including the Digital Light Processor (DLP) from Texas Instruments, Dallas, Tex., or Liquid Crystal Devices (LCDs). A considerable amount of heat can result when the intense light from laser or other sources is concentrated onto the SLM. Unless it is removed, this heat can quickly degrade component performance and image quality and, if allowed to rise to high levels, can destroy the SLM. Thus, solutions are needed for quickly and efficiently removing excess heat from the SLM device during operation.

Conventional solutions for cooling the SLM include passive devices, such as heat sinks, used with numerous types of solid-state electronic components. Convection cooling from the heat sink can be supplemented by fans or other devices to promote air circulation in order to draw heat away from the heat sink. As SLMs are reduced in size and light sources increase in intensity, however, a more aggressive cooling solution is typically required.

In response to this need, solutions using liquid coolant have also been proposed for providing heat management within laser projection apparatus. Using this type of solution, water or other liquid coolant is pumped along and around heat-generating and heat-sensitive components through a series of conduits, typically also leading to a radiator or other device for lowering the coolant temperature. Solutions for cooling electronic components that combine fin structures familiar to heat sink designs with liquid coolant flow include that shown in U.S. Pat. No. 7,331,380 entitled “Radial Flow Microchannel Heat Sink with Impingement Cooling” to Ghosh et al. Coolant devices and systems directed more particularly to the requirements of projection apparatus are disclosed, for example, in U.S. Patent Publication No. 2007/0165190 entitled “Heat Exchanger, Light Source Device, Projector and Electronic Apparatus” by Takagi, and U.S. Pat. No. 7,226,171 entitled “Optical Device and Projector” to Fujimori et al.

Although the use of liquid coolant is a step forward over heat-sink and forced-air cooling solutions, however, there is still a need for improvement. Unlike the heat problems presented with electronic components and packaging, the heat generation that is encountered by the SLM is concentrated within a much smaller area. Thus, conventional approaches that are designed to cool electronic circuitry by spreading out the heat more evenly prove to be poorly suited to the more localized cooling requirements for DMDs and other types of SLMs.

Thus, there is a need for a component cooling solution that compensates for the intense, localized heat that is typical of the SLM environment, particularly where laser light and other high-energy light source is concentrated over a small area.

### SUMMARY OF THE INVENTION

The present invention addresses the need for localized cooling of a spatial light modulator (SLM) in an electronic projector or other imaging apparatus. This need is met by providing a cooling cell for drawing heat from a light modulator comprising an enclosure for conducting a fluid coolant, the enclosure comprising:
a) a fluid coolant inlet disposed to receive a flow of fluid coolant under pressure into the enclosure;
b) a fluid conduit disposed to provide fluid communication from the fluid coolant inlet to a nozzle;
c) a well cavity formed surrounding the nozzle and having a plurality of fins that extend radially upward from a bottom of the well cavity and extend outward from the well cavity along a shallow cavity that is peripheral to the well cavity and that is shallower than the well cavity, wherein the well cavity is formed within a protruding element that protrudes outward from a portion of an external surface of the enclosure and wherein the protruding element provides a component mounting surface that lies behind the bottom of the well cavity; and
d) at least one fluid coolant discharge outlet for discharging fluid coolant from the enclosure.

It is a feature of the present invention that it directs liquid coolant against the back side of a surface that is used to mount an SLM that receives intense light energy.

It is an advantage of the present invention that it draws heat outward and away from the rear surface of the SLM, thereby removing heat that is incident over a small area.

It is a further advantage of the present invention that it provides a compact cooling cell that is adaptable for the dense packing requirements of an electro-optical light modulator.

These and other features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a perspective view of a cooling cell in an embodiment of the present invention;

FIG. 2 is a perspective view of a cooling cell from the underside in the embodiment of FIG. 1;

FIG. 3 is a perspective sectioned view of the cooling cell;

FIG. 4 is a plan sectioned view of the cooling cell;

FIG. 5 is an exploded view showing assembly of the cooling cell in an embodiment of the present invention;

FIG. 6 is a sectioned view of the exploded view shown in FIG. 5;

FIG. 7 is a plan view showing the base as seen from its internal fluid chamber side;

FIG. 8 is a perspective view of the base, showing the direction of fluid coolant flow upward and outward from the well cavity;

FIG. 9 is a perspective sectioned view of the base; and

FIG. 10 shows a simplified block diagram of a projector apparatus that uses DLP spatial light modulators with the cooling cell of the present invention.

### DETAILED DESCRIPTION OF THE INVENTION

Figures shown and described herein are provided to illustrate principles of operation and structure according to embodiments of the present invention and may not be drawn with intent to show actual size or scale. Because of the relative dimensions and compactness of the component parts for the cooling cell of the present invention, a number of different views of the cooling cell are shown, including exploded views of the overall assembly and sectional views of the assembly and of major components in an embodiment of the present invention.

The terms “bottom” or “underside”, “top”, “behind”, and similar terms are used to indicate opposite surfaces or other features of components as described and illustrated herein, but are not intended to limit a component to a vertical or horizontal or facing orientation. Similarly “downward” and “upward” are used to describe directions for fluid flow relative to the shape of directing structures and do not define directions relative to the mounting orientation of the cooling device. It can be noted that one advantage of the cooling cell of the present invention relates to its adaptability for orientation in any direction, unlike a heat sink, in which, to take advantage of convection effects, cooling fins must normally be disposed in a vertical orientation and must be above the component being cooled.

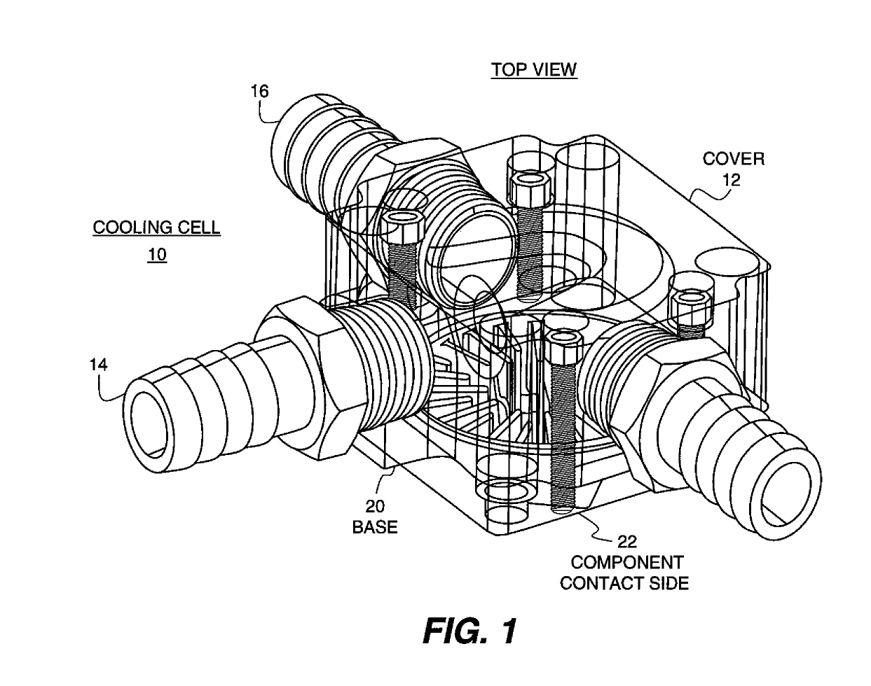

Referring to FIG. 1, there is shown a cooling cell 10 that provides an enclosure for conducting a fluid coolant. Cooling cell 10 is presented in the view of FIG. 1 with a level of transparency that allows some visibility of its internal geometry and components. Cooling cell 10 has a cover 12 that is fitted onto a base 20 and includes a fluid coolant inlet 14 and at least one fluid coolant discharge outlet 16. Base 20 is formed of a heat-conductive metal, such as stainless steel, or of a suitable ceramic or other heat-conductive material.

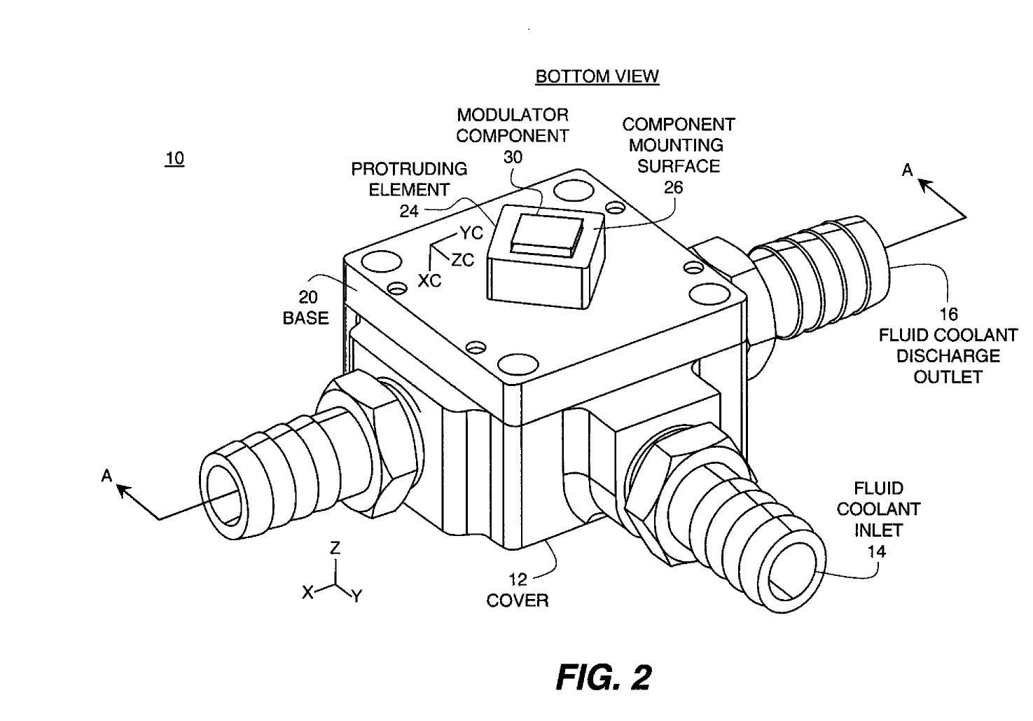

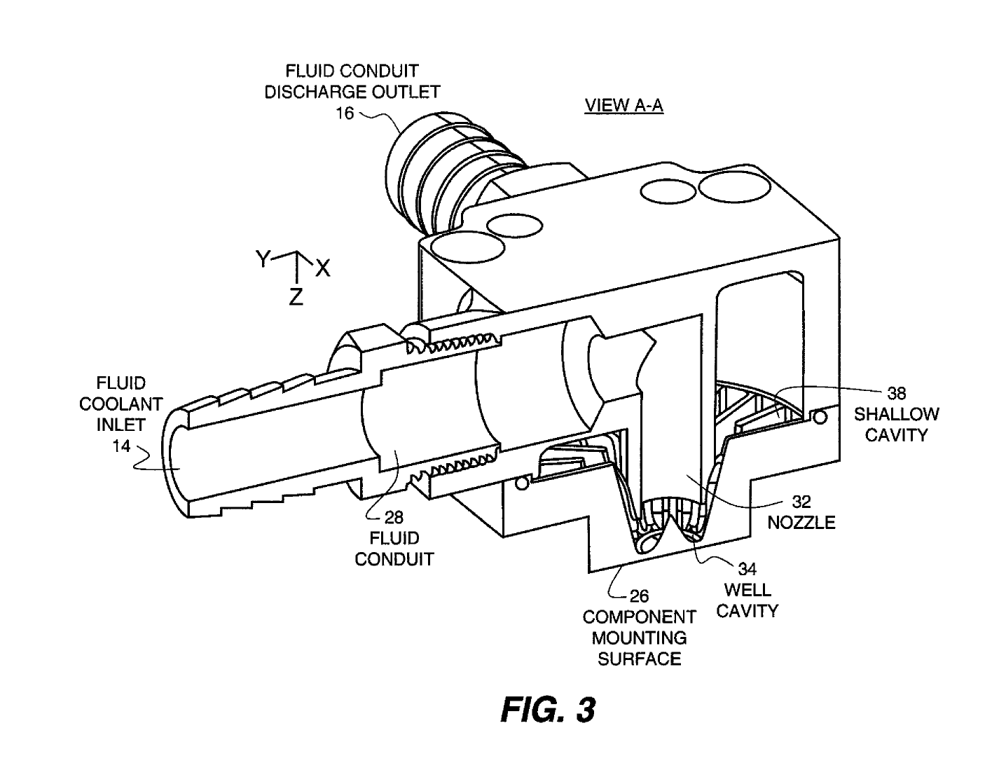

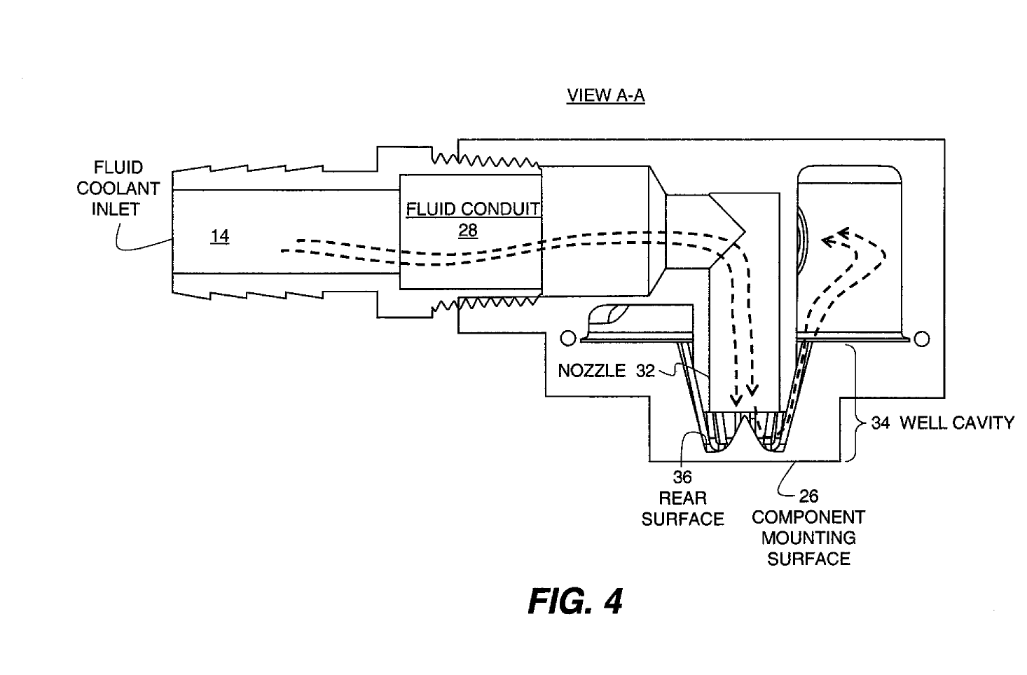

As is shown in the view from the underside of cooling cell 10 in FIG. 2, base 20 has an external component contact side 22 that has a protruding element 24 that provides a component mounting surface 26 for mounting a modulator component 30, such as a DMD or other type of reflective SLM, or other component subject to heat generation. The perspective sectioned view of FIG. 3 and plan sectioned view of FIG. 4, both taken from A-A in FIG. 2, show the internal arrangement of cooling cell 10 components. Fluid coolant inlet 14 directs liquid coolant to a fluid conduit 28 that provides fluid communication to a nozzle 32. Nozzle 32 extends downward toward and into a well cavity 34 that is formed on an internal fluid chamber side 36 along the rear surface of base 20. Well cavity 34 is formed within protruding element 24, along the rear wall that lies behind component mounting surface 26.

FIG. 4 shows the basic coolant flow direction in dashed lines, to show how nozzle 32 is configured to force the flow of fluid coolant directly against the rear side of component mounting surface 26. The fluid coolant exits nozzle 32 within well cavity 34 so that the fluid coolant is directed, under pressure from the external coolant flow system, against the rear wall of component mounting surface 26. This directs the fluid coolant at its coolest temperature, right up against the back of component mounting surface 26. The fluid coolant is then forced upward (in the orientation shown in FIGS. 3 and 4 and elsewhere) and outward from well cavity 34 into a shallow cavity 38 that is peripheral to well cavity 34, as is shown in more detail subsequently. Fluid coolant is then directed out of cooling cell 10 from one or more fluid coolant discharge outlets 16. Not shown in figures of this disclosure are the necessary pump and radiator that provide forced cooling of the fluid coolant itself, using any of a number of configurations that are well understood to those skilled in the component cooling art.

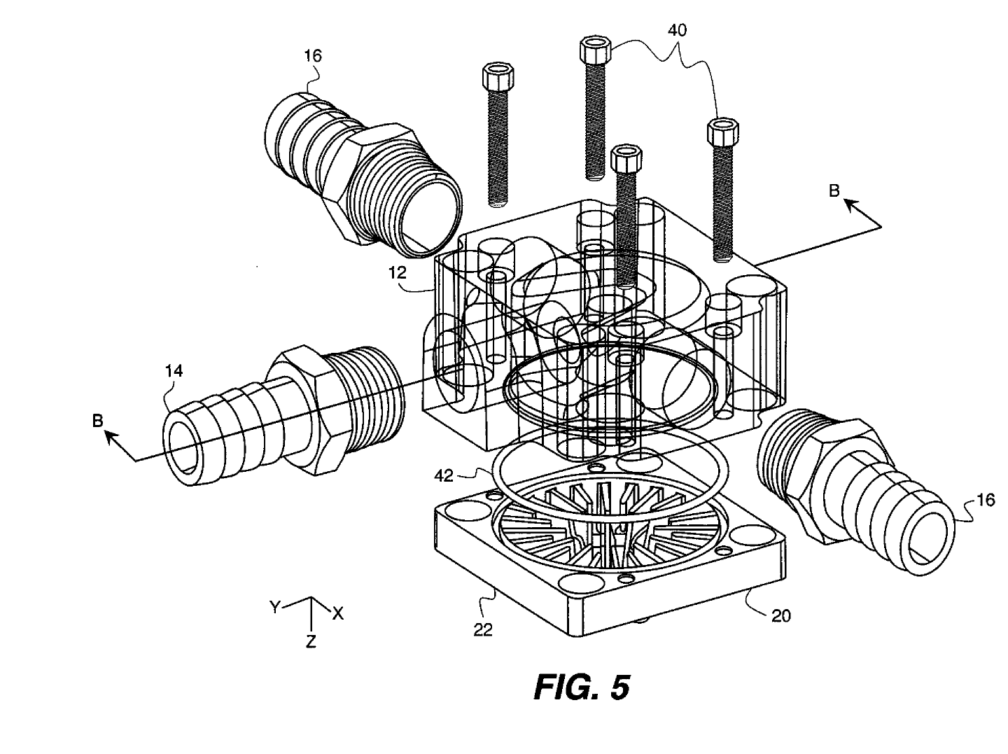

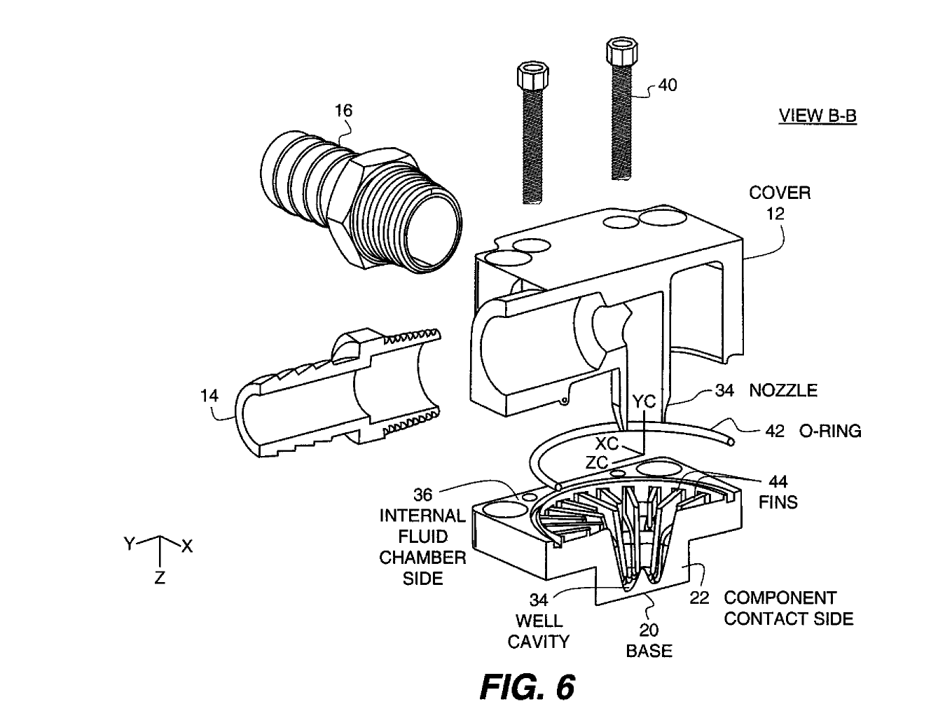

The exploded view of FIG. 5 shows how cooling cell 10 is assembled in one embodiment. Cover 12, formed of a plastic material in one embodiment, is fitted against base 20, typically using one or more fasteners 40, shown as screws in FIG. 5. An O-ring or other type of seal 42 is also provided between base 20 and cover 12. The sectioned exploded view of FIG. 6, taken along B-B in FIG. 5, shows additional detail, particularly showing how nozzle 32 extends downward to forcibly direct fluid coolant directly into well cavity 34.

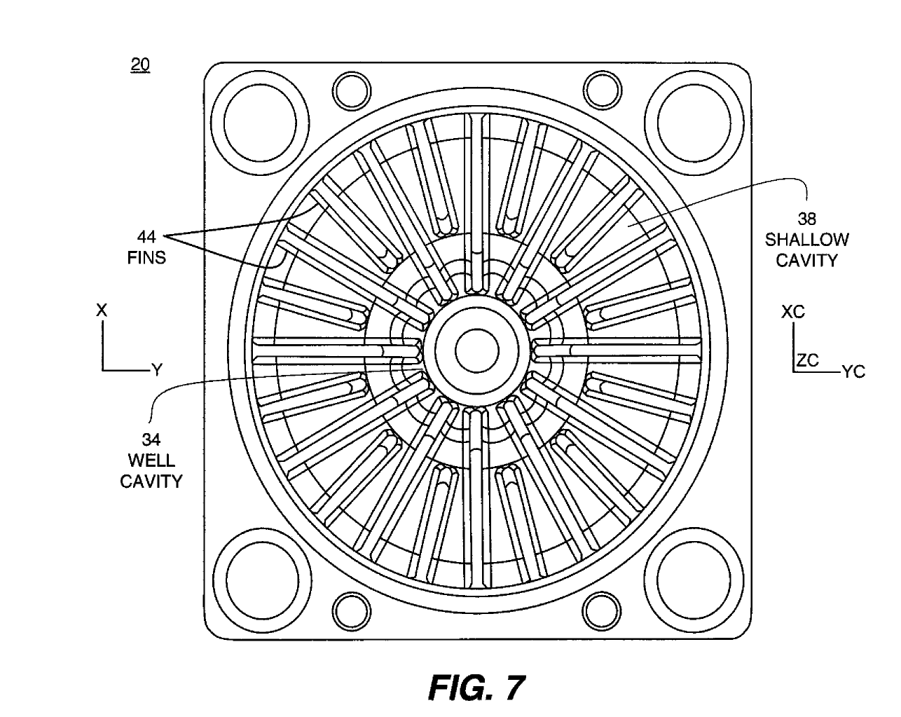

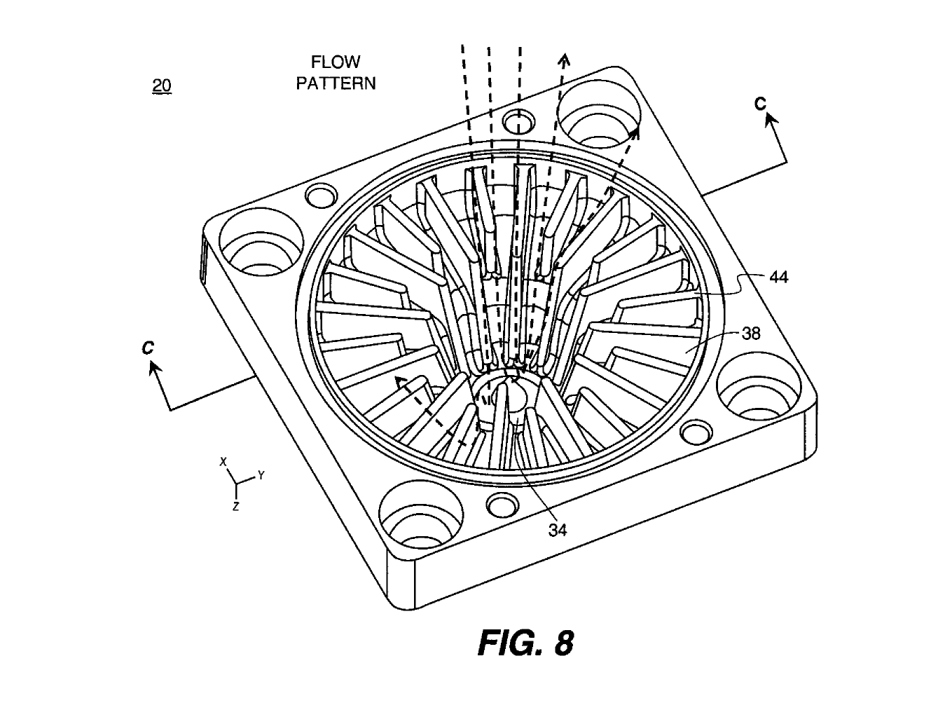

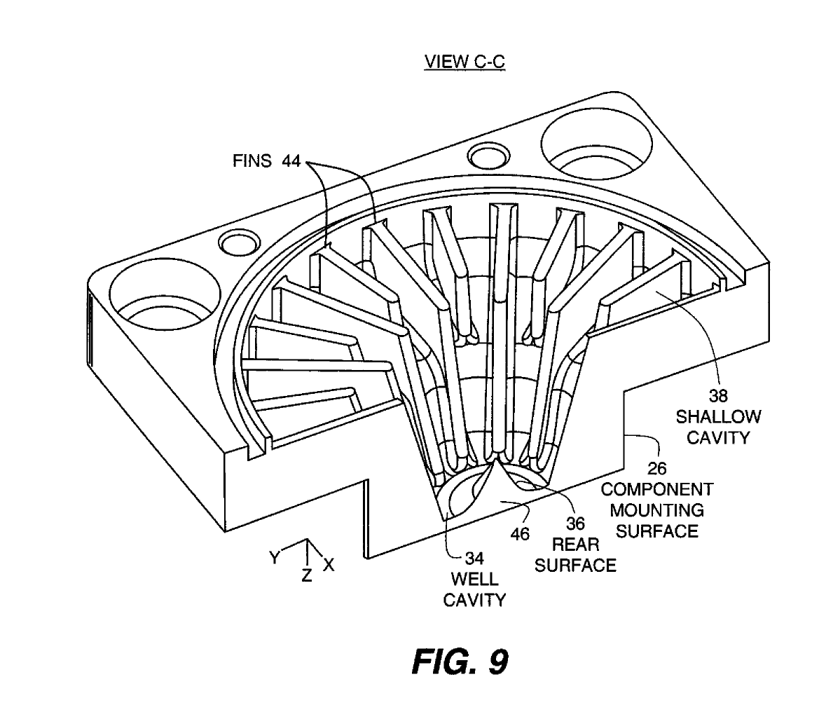

The plan view of FIG. 7 shows base 20 as seen from internal fluid chamber side 36. A number of fins 44 extend radially upward and outward from well cavity 34 and help to direct the fluid coolant away from well cavity 34. The perspective view of base 20 in FIG. 8 shows fluid coolant flow, again in dotted lines, upward and outward from well cavity 34 into peripheral shallow cavity 38. The sectioned view of FIG. 9, taken along C-C in FIG. 8, shows the internal geometry of base 20 with fins 44 in greater detail. Some of the fins 44 extend radially upward from the bottom of well cavity 34, then continue outward along shallow cavity 38. Other fins 44 do not ascend from well cavity 34 in this embodiment, but begin and end only within shallow cavity 38. A cone 46 at the bottom of well cavity 34 helps to direct the flow of fluid coolant against the rear wall of component mounting surface 26 and radially outward.

The arrangement of cooling cell 10 components allows this device to be used in any orientation, so that modulator component 30 can be mounted in an appropriate orientation for the optical path inside the projector or other imaging system. By directing fluid coolant directly against the back side of component mounting surface 26, cooling cell 10 draws heat that is concentrated on modulator component 30 and directs this heat upward from well cavity 34 and outward so that it can exit cooling cell 10 and be cooled elsewhere in the cooling system.

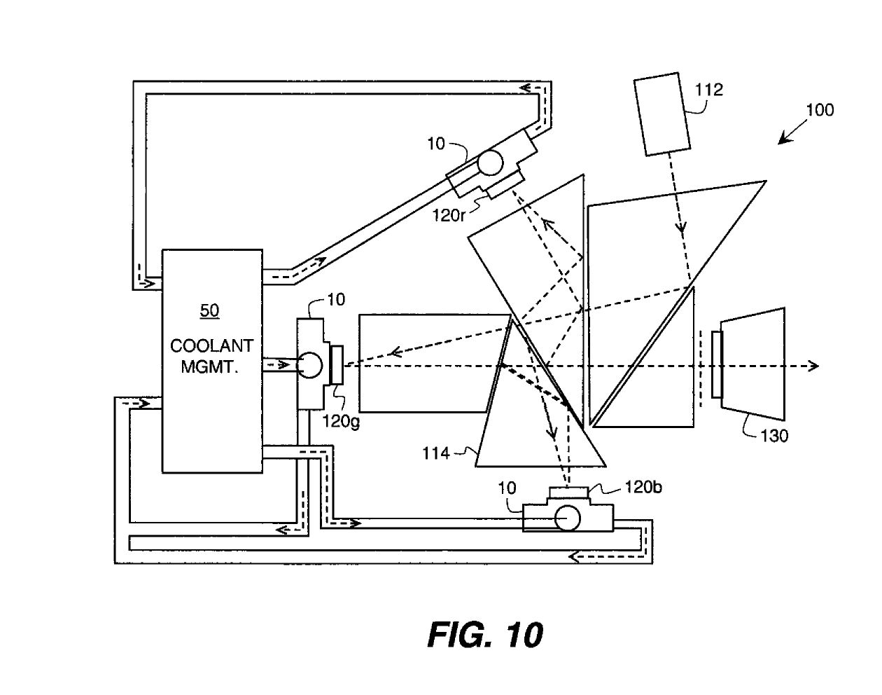

FIG. 10 shows a simplified block diagram of a projector apparatus 100 that uses DLP spatial light modulators and a single laser or other light source 112 with cooling cell 10 of the present invention. In this embodiment, light source 112 provides polychromatic light into a prism assembly 114, such as a Philips prism, for example. Prism assembly 114 splits the polychromatic light into red, green, and blue component bands and directs each band to the corresponding spatial light modulator 120r, 120g, or 120b. Prism assembly 114 then recombines the modulated light from each SLM120r, 120g, and 120b and provides this light to a projection lens 130 for projection onto a display screen or other suitable surface. Each spatial light modulator 120r, 120g, and 120b has a cooling cell 10 with fluid coolant routing to and from a coolant management apparatus 50. Fluid coolant routing and management external to cooling cell 10 and provided through coolant management apparatus 50 is not described in detail in the present disclosure and can take any form that is deemed suitable for the particular projector or other device in which cooling cell 10 is used. Water or other type of fluid coolant can be used. Variables such as appropriate fluid pressure, tubing types and dimensions, routing practices, pump or radiator types, cooling techniques, and other variables are well known to those skilled in the component cooling art. In other embodiments, a separate laser or other light source 112 may be provided for the SLM within each color channel, increasing the heat generated and thus cooling requirements correspondingly.

Embodiments of the present invention thus address the need for cooling over the small area of the DMD or other SLM, providing a cooling solution that is suited to the stringent cooling requirements of a laser projector or similar apparatus. Advantageously, cooling cell 10 is compact, allowing dense packaging of the SLM and its supporting optics. Cooling cell 10 provides a cooling enclosure that has a relatively small parts count, and can be scaled to accommodate the dimensions and geometry of a reflective SLM, as well as the requirements of refractive modulator devices, such as the grating light valve (GLV) or grating electromechanical systems (GEMS) modulator.

Base 20 can be formed from any of a number of types of metal, using conventional molding techniques or using machining techniques made possible by Computerized Numerical Control (CNC) for single-part construction. EDM machining (Electrical Discharge Machining) is one specialized form of CNC machining that can be used for precision fabrication of complex parts from metal and other hard, conductive materials. Briefly, EDM selectively erodes material from a workpiece of a conductive substance by providing an electrical discharge across the gap between an electrode and the material to be removed. A dielectric fluid continually flows in the gap area around the electrode and flushes out the removed material. Wire EDM is one form of EDM, using a continuously moving wire as its electrode. Other techniques that may be suitable for fabricating base 20 can include conventional machining, laser machining, various etching techniques, water jets, and machining technologies in general that remove material from a solid block, forming and shaping cavities and structures of defined dimensions, controlling their overall contour and depth. Optionally, a suitable ceramic or other non-metallic heat-conductive material can be used.

The invention has been described in detail with particular reference to certain preferred embodiments thereof, but it will be understood that variations and modifications can be effected within the spirit and scope of the invention. For example, cover 12 can be plastic, metal, ceramic, or other suitable material. Nozzle 32 can be formed as part of cover 12, or can be a separate component or can be formed as part of base 20. Cooling cell 10 can also be configured to support other types of electronic or electro-optical components in addition to SLMs, such as gratings or other diffractive devices, reflectors, dichroic surfaces, or beam splitters, for example. Thus, what is provided is an apparatus and method for cooling any type of component, particularly one for which intense heat is generated over a relatively small area.

### Parts List

10 Cooling cell
12 Cover
14 Fluid coolant inlet
16 Fluid coolant discharge outlet
20 Base
22 External component contact side
24 Protruding element
26 Component mounting surface
28 Fluid conduit
30 Modulator component
32 Nozzle
34 Well cavity
36 Internal fluid chamber side
38 Shallow cavity
40 Fastener
42 Seal
44 Fin
46 Cone
50 Coolant management apparatus
100 Projector apparatus
112 Light source
114 Prism assembly
120r, 120g, 120b Spatial light modulators
130 Projection lens

What is claimed is:

1. A cooling cell for drawing heat from a light modulator comprising an enclosure for conducting a fluid coolant, the enclosure comprising:
a) a fluid coolant inlet disposed to receive a flow of fluid coolant under pressure into the enclosure;
b) a fluid conduit disposed to provide fluid communication from the fluid coolant inlet to a nozzle;
c) a well cavity formed surrounding the nozzle and having a plurality of fins that extend radially upward from a bottom of the well cavity and extend outward from the well cavity along a shallow cavity that is peripheral to the well cavity and that is shallower than the well cavity, wherein the well cavity is formed within a protruding element that protrudes outward from a portion of an external surface of the enclosure and wherein the protruding element provides a component mounting surface that lies behind the bottom of the well cavity; and
d) at least one fluid coolant discharge outlet for discharging fluid coolant from the enclosure.

2. The cooling cell of claim 1 wherein the fluid coolant comprises water.

3. The cooling cell of claim 1 comprising a cover that provides at least the fluid coolant inlet and fluid coolant discharge outlet and a base that provides the well cavity.

4. A cooling cell for a light modulator comprising:
a) a base having an external component contact side and, opposite the external component contact side, an internal fluid chamber side, wherein the component contact side provides a protruding element with a component mounting surface and wherein the internal fluid chamber side is featured to provide a hollowed well cavity that extends into the protruding element and behind the component mounting surface and having a plurality of fins that extend radially outward from within the well cavity and extend along a shallow cavity that is peripheral to the well cavity;
b) a cover that mounts to the base to define an enclosure for a fluid coolant, the cover comprising:
a fluid conduit that extends from a fluid coolant inlet to a nozzle that extends into the well cavity for directing the fluid coolant towards a rear surface of the component mounting surface, and further comprising at least one fluid coolant discharge outlet.

5. The cooling cell of claim 4 wherein the base is formed from metal.

6. The cooling cell of claim 4 wherein the cover is formed from plastic.

7. A projection apparatus using the cooling cell of claim 4 for each of a plurality of spatial light modulators.

8. A method for drawing heat from a light modulator comprising:
a) directing a pressurized flow of fluid coolant within an enclosure against a rear wall of a protruding element that provides a component mounting surface on the side of the enclosure opposite the rear wall and guiding the pressurized flow of fluid coolant away from and outward from the rear wall of the protruding element and along a set of cooling fins that extend away from and outward from the rear wall and into a shallow cavity that lies within the enclosure and is peripheral to the protruding element; and
b) directing the fluid coolant out of the enclosure through at least one coolant discharge outlet.
